(19) United States
(12) Patent Application Publication
(10) Pub. No.: US 2003/0131511 A1
(43) Pub. Date: Jul. 17, 2003

(54) Formative sticker with multiple layers of combinable parts

(75) Inventor: Ming Te Lai, (US)

Correspondence Address: BRUCE H. TROXELL, 5205 LEESBURG PIKE, SUITE 1404, FALLS CHURCH, VA, 22041, US

(73) Assignee: Jean Card and Gift Co., Ltd.

(21) Appl. No.: 10/047,086

(22) Filed: Jan. 17, 2002

(51) Int. Cl. G09F 3/10

(52) U.S. Cl. 40/638; 40/594

(57) ABSTRACT

A formative sticker with multiple layers of combinable parts is particularly suitable for adhering an article to a desired place or directly attaching to an article as a good decoration thereof. The formative sticker mainly includes a base part, an adhering part pre-attached to a bottom of the base part and having one side facing away from the base part provided with a layer of adhesive, and at least one formative part for differently combined with the base part to construct different three-dimensional configurations that provide good decorative effect when the sticker attaches an article to the desire place.

### BACKGROUND OF THE INVENTION

The present invention relates to a formative sticker with multiple layers of combinable parts, and more particularly to a formative sticker that creates a three-dimensional decorative effect.

A sticker typically includes a first side that is usually a bottom side being applied with a layer of adhesive, and a second side that is usually a top side opposite to the first side and is non-adhesive. The sticker may be directly attached at the adhesive first side to any desired place or be used to attach something to a desired location. For example, multiple pieces of such stickers maybe first overlapped with corners of a photo, and portions of the adhesive side of the stickers extended beyond the photo could then attach the photo to a desired visible place.

In addition to provide the locating function via the adhesive first side, the above-described sticker may also be used as a decorative means by providing the non-adhesive second side with various shapes or printed designs. Thus, the stickers attaching something to a desired position also make the attached thing more attractive.

A disadvantage of the conventional stickers is their non-adhesive second sides are always in a plane after being adhered to the desired place, no matter how many different shapes and/or printed designs are provided on the second sides.

### SUMMARY OF THE INVENTION

It is therefore a primary object of the present invention to provide a formative sticker with multiple layers of combinable parts to eliminate drawbacks existing in the conventional stickers.

To achieve the above and other objects, the formative sticker of the present invention mainly includes a base part, an adhering part pre-attached to a bottom of the base part and having one side facing away from the base part provided with a layer of adhesive, and at least one formative part for differently combined with the base part to construct different three-dimensional configurations that provide good decorative effect when the sticker attaches an article to a desire place or is attached to an article.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a formative sticker according to a preferred embodiment of the present invention;

FIG. 2 is an exploded perspective view of FIG. 1;

FIG. 3 is a sectioned perspective view of FIG. 1;

FIG. 4 shows a first example of using the formative sticker of the present invention to fix an article to a desired position; and

FIG. 5 shows a second example of using the formative sticker of the present invention to decorate an article.

### DETAILED DESCRIPTION OF THE PREFERRED EMBODIMENTS

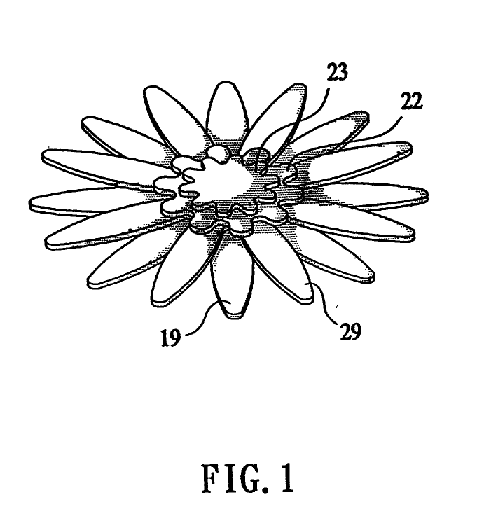

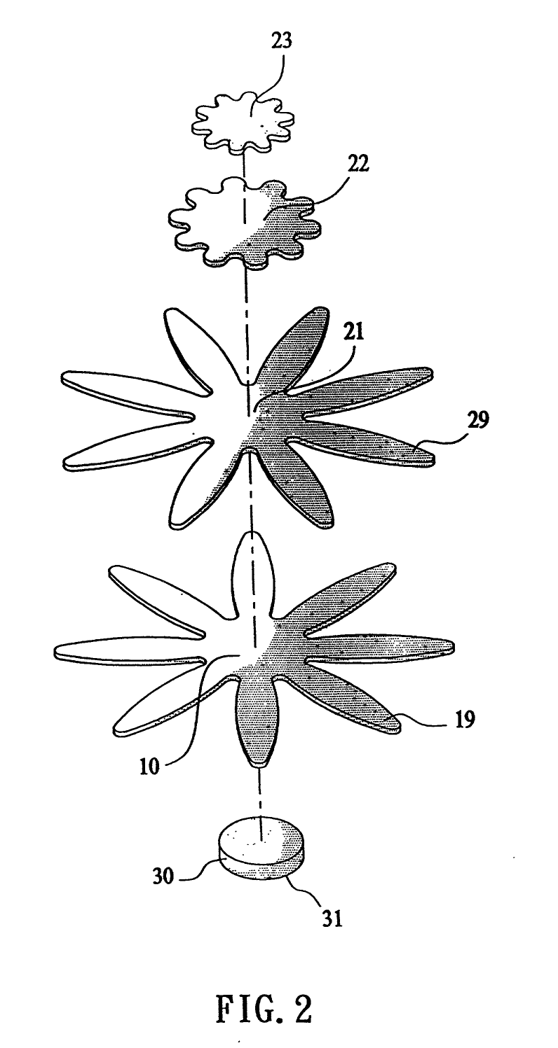

Please refer to FIGS. 1 through 3 that are assembled, exploded, and sectioned perspective views, respectively, of a formative sticker with multiple layers of combinable parts according to an embodiment of the present invention. In this embodiment, the formative sticker has the form of a three-dimensional flower. However, it is understood the formative sticker of the present invention may be of many other forms and configurations.

In the illustrated preferred embodiment, the three-dimensional flower-shaped sticker includes a base part 10, first, second and third formative parts 21, 22, 23 for connecting to a top of the base part 10, and an adhering part 30 for connecting to a bottom of the base part 10.

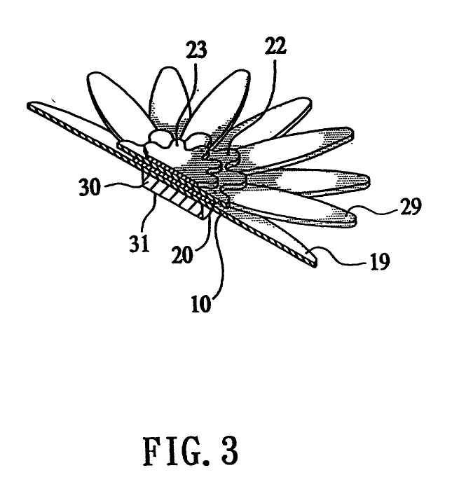

The first, the second, and the third formative parts 21, 22, and 23 are sequentially connected to the top of the base part 10 from bottom to top. In the illustrated embodiment, the base part 10 is in a shape of a lowest or outmost corolla of a flower and includes a plurality of radially extended and angularly spaced petals 19. The first formative part 21 is in a shape corresponding to the base part 10 and includes a plurality of radially extended and angularly spaced petals 29. The first formative part 21 is superposed on the top of the base part 10 with the petals 29 alternating with the petals 19, as shown in FIGS. 1 and 3, for the sticker to have visually densely distributed petals. The second and the third formative parts 22 and 23 are then sequentially superposed on a central area of a top of the first formative part 21 to form a center of a flower.

The adhering part 30 is connected to a bottom of the base part 10 and is provided on at least one side 31 facing away from the base part 10 with a layer of adhesive for adhering the entire formative sticker having the above-described parts 10, 21, 22, and 23 to a desired place.

The adhering part 30 is pre-attached to the bottom of the base part 10, and the multiple layers of matching formative parts are freely combined and connected to the top of the base part 10. With the formative parts 21, 22 and 23 differently combined with the base part 10, it is possible for the entire combined formative stacker to show different shapes or forms in three dimensions, including the illustrated flower and many other configurations, and serve as a unique decoration or ornament.

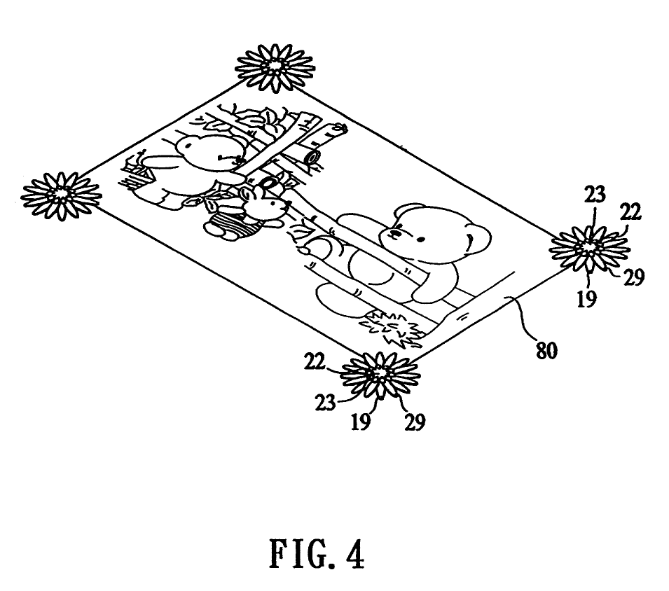

FIG. 4 shows a plurality of the multi-layered formative stickers according to the embodiment shown in FIGS. 1 to 3 are overlapped with four corners of a photo 80 to adhere the photo 80 to any desired position and make the photo 80 looked more attractive.

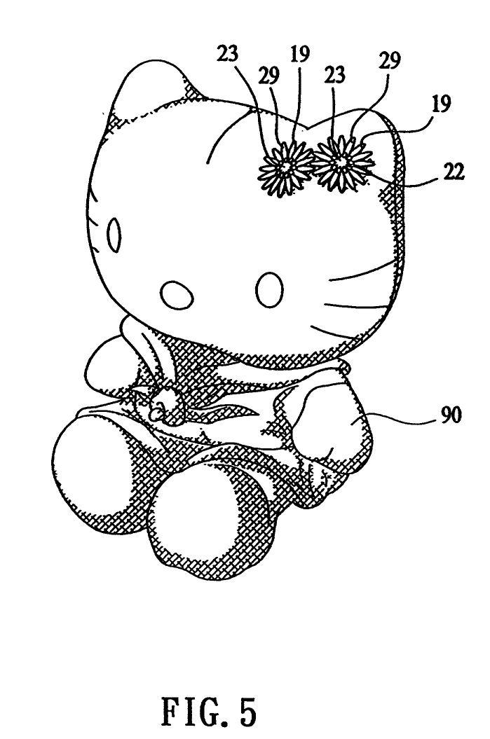

FIG. 5 shows another manner of using the multi-layered formative sticker of the present invention. A plurality of the three-dimensional formative stickers are directly attached to the surface of a toy 90 close to a head thereof, making the toy visually lovely and adorable. The formative stickers with multiple layers of combinable parts are apparently very useful in terms of its decorating effect.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A formative sticker with multiple layers of combinable parts, comprising a base part, an adhering part that is pre-attached to a bottom of said base part and has one side facing away from said base part being applied with a layer of adhesive, and at least one formative part for freely connecting to a top of said base part to together with said base part show a certain three-dimensional configuration.

2. The formative sticker with multiple layers of combinable parts as claimed in claim 1, wherein said three-dimensional configuration is a flower.

3. The formative sticker with multiple layers of combinable parts as claimed in claim 2, wherein said three-dimensional flower includes said base part, and first, second, and third formative parts sequentially connected to the top of said base part from bottom to top, and wherein said base part and said first formative parts include a plurality of radially extended and angularly spaced petals, and said first formative part is superposed on said base part with said petals of said base part alternating with said petals of said first formative part, and said second and said third formative parts together form a top center of said flower.
